(19) United States
(12) Patent Application Publication
(10) Pub. No.: US 2008/0257514 A1
(43) Pub. Date: Oct. 23, 2008

(54) APPARATUS AND METHOD FOR TREATING A FIBROUS WEB, IN PARTICULAR FOR PRODUCING A TISSUE PAPER WEB

(76) Inventors: Thomas Scherb, Sao Paulo (BR); Luiz Carlos Silva, Camp Limpo (BR); Rogerio Berardi, Sao Paulo (BR)

Correspondence Address: Todd T. Taylor;Taylor & Aust, P.C., P.O. Box 560, 142 S. Main Street, Avilla, IN, 46710, US

(21) Appl. No.: 12/138,911

(22) Filed: Jun. 13, 2008

Related U.S. Application Data
(63) Continuation of application No. PCT/EP2006/068278, filed on Nov. 9, 2006.

(30) Foreign Application Priority Data
Dec. 16, 2005 (DE) 10 2005 060 379.3

(51) Int. Cl. B31F 1/18

(52) U.S. Cl. 162/281; 162/280

(57) ABSTRACT

Apparatus for treating a fibrous web, in particular for producing a tissue paper web, with at least one crêping nip which is limited on the one side by a crêping belt and on the other side by a web supporting face formed in particular by a mating roll and through which the fibrous web can be passed, whereby a relative speed is provided between the crêping belt and the web supporting face, whereby in order to achieve a good crêping effect with simultaneous little crêping belt wear the material and/or the structure of the web supporting face and the surface of the crêping belt are coordinated with each other with a view to reducing the crêping belt wear caused by operation of the apparatus.

This is a continuation of PCT application No. PCT/EP2006/068278, entitled “DEVICE AND METHOD FOR TREATING A WEB OF FIBROUS MATERIAL, IN PARTICULAR FOR PRODUCING A WEB OF TISSUE PAPER”, filed Nov. 9, 2006, which is incorporated herein by reference.

### BACKGROUND OF THE INVENTION

1. Field of the Invention

The present invention relates to an apparatus for treating a fibrous web, in particular for producing a tissue paper web, with at least one crêping nip which is limited on the one side by a crêping belt and on the other side by a web supporting face formed in particular by a mating roll and through which the fibrous web can be passed, whereby a relative speed is provided between the crêping belt and the web supporting face.

2. Description of the Related Art

The technology for producing tissue paper webs is known in principle. For example, a tissue paper web is mechanically pressed in a press nip, whereby the tissue paper web is carried by a roll face at a first speed. The web is picked up by a permeable, woven belt with a structured surface at a second speed, whereby the second speed is lower than the first speed. The objective in this case is to create a high-bulk tissue paper web by means of a so-called crêping effect. Here the press nip thus forms a crêping nip. However, crêping without pressing force and only with a relative speed in the crêping nip is also possible. What is needed in the art is to achieve a good crêping effect while reducing the crêping belt wear.

### SUMMARY OF THE INVENTION

The present invention provides an apparatus wherein the material and/or the structure of the web supporting face and the surface of the crêping belt are coordinated with each other to reduce the crêping belt wear caused by operation of the apparatus.

Up to now the material and structure of the web supporting face were selected solely with a view to achieving a good crêping effect. An influence on the crêping belt wear was not known up to now. In connection with the present invention it was discovered namely that the crêping belt in the crêping nip is not separated from the web supporting face but the crêping belt, or at least the humps of a structured and rough belt, are thrust against the web supporting face in spite of the fibrous web lying in between. The reason is that on the one hand the fibrous web is relatively thin and light, namely approximately 15 g/m² to approximately 40 g/m², and on the other hand the humps push the fibers of the fibrous web aside on account of the crêping operation. These problems are resolved by the present invention. In the present invention, coordination is undertaken such that a small coefficient of friction between the crêping belt and the web supporting face results. Little friction leads to little wear of the crêping belt.

In the present invention the humps of the crêping belt are formed from a soft material. In particular the humps have preferably a hardness between approximately 20 and approximately 120 Pussey & Jones. Small coefficients of friction and little crêping belt wear can thus be obtained. The web supporting face is comprised preferably of polytetrafluoroethylene (PTFE), while in principle any material, in particular a normal crêping belt material can be used for the crêping belt. Also, the use of PTFE for the web supporting face leads to a small coefficient of friction and hence to little crêping belt wear. A press nip can be positioned upstream from the crêping nip. The press nip can be constructed as a longitudinal nip, a shoe press nip, a roll nip or simply a felted nip. The production process can be improved further as the result.

The crêping belt is comprised of structured fabric such as TAD fabric or spiral-linked fabric. Such material has proven to be particularly advantageous for the crêping effect. In addition, the crêping belt can be permeable or non-permeable, and be made of woven or non-woven material. Advantages can be drawn likewise therefrom.

Arranged downstream from the crêping nip there can be a drying cylinder, in particular a Yankee cylinder. A crêping nip can be constructed on a drying cylinder, in particular a Yankee cylinder. Through the use of a drying cylinder, the crêping effect can be improved further.

According to another embodiment of the present invention there can be constructed on the drying cylinder, in particular by means of a mating roll, a press nip through which the fibrous web is passed together with the crêping belt. Again, the crêping process can be improved further as the result. The contact area between the crêping belt and the drying cylinder and/or between the crêping belt and the mating roll is preferably between approximately 20% and approximately 70%, more preferably between approximately 25% and 50% and still more preferably approximately 30%. Very little wear and very good quality of the tissue paper web can thus be obtained. Through the small contact area, pockets in which the high-bulk crepe material is protectively received are created in the regions lying in between. Nevertheless, good pressing of the fibrous web and good tensile strength are achievable through the use of the drying cylinder.

The press nip on the drying cylinder can be formed by a suction press roll, a press roll or a shoe press roll with an extended roll nip. Good results can be achieved therewith. The crêping nip can be formed furthermore with or without mechanical pressing means. Also, it is possible for different crêping nips to be combined with each other. In this way production can be improved further. A soft press roll, a hard press roll or a belt press can be provided as mechanical pressing means. Such pressing means are particularly suited for the intended purpose.

In the event of using a belt press, the belt has a tensile strength of at least 40 kN/m, preferably at least 50 kN/m and more preferably at least 60 kN/m. The required pressing force can thus be achieved.

The apparatus of the present invention is used preferably for fibrous webs with a mass of approximately 15 g/m² to approximately 40 g/m². With such thin and light fibrous webs the problem of wear on the crêping belt is particularly great, and so are therefore the advantages achieved by the current invention.

On the side of the crêping belt opposite the mating roll, provision can also be made for a crêping roll or a suction press roll. The rolls can have the following properties:

Mating roll:
1. Composite/resin (TOPROCK): 11.5 to 13.5 mm thick, roughness from 0.5 to 2.5 μm Ra, hardness 88 to 94 Shore D, finely ground.
2. Composite: 10 to 25 mm thick, roughness from 0.5 to 2.5 μm Ra, hardness 88 to 94 Shore D, finely ground.
3. Polyurethane: 10 to 25 mm thick, roughness from 0.5 to 2.5 μm Ra, hardness 4 to 200 P&J, finely ground.
4. Rubber: 5 to 25 mm thick, roughness from 0.5 to 2.5 μm Ra, hardness 78 to 85 Shore D, finely ground.
5. Rubber: 5 to 25 mm thick, roughness from 0.5 to 2.5 μm Ra, hardness 1 to 50 P&J, finely ground.
6. Tungsten carbide: 0.1 to 0.8 mm thick, roughness from 0.03 to 1.0 μm Ra, hardness 900 to 1400 HV, finely ground and super-finished.
7. Chromium carbide: 0.1 to 0.8 mm thick, roughness from 0.03 to 1.0 μm Ra, hardness 800 to 1200 HV, finely ground and super-finished.
8. Ni/Cr chromium carbide: 0.1 to 0.8 mm thick, roughness from 0.03 to 1.0 μm Ra, hardness 800 to 1200 HV, finely ground and super-finished.
9. Tungsten carbide+PTFE layer: 0.1 to 0.8 mm thick, roughness from 0.03 to 2.5 μm Ra, hardness 900 to 1400 HV, finely ground or not.
10. Stainless steel: 0.1 to 2.5 mm thick, roughness from 0.5 to 1.5 μm Ra, hardness 28 to 42 HRC, finely ground.
11. Chromium-plated: 0.05 to 0.25 mm thick, roughness from 0.5 to 1.5 μm Ra, hardness 700 to 1200 HV, finely ground.

Crêping roll/suction press roll:
1. Rubber: 7 to 25 mm thick, roughness from 0.5 to 2.5 μm Ra, hardness 78 to 85 Shore D, with or without blind bore holes, finely ground.
2. Polyurethane: 10 to 25 mm thick, roughness from 0.5 to 2.5 μm Ra, hardness 4 to 200 P&J, with or without blind bore holes, with or without flutes and combination of blind bore holes and suction holes, finely ground.
3. Tungsten carbide: 0.1 to 0.8 mm thick, roughness from 0.03 to 1.0 μm Ra, hardness 900 to 1400 HV, finely ground and super-finished.
4. Chromium carbide: 0.1 to 0.8 mm thick, roughness from 0.03 to 1.0 μm Ra, hardness 800 to 1200 HV, finely ground and super-finished.
5. Ni/Cr chromium carbide: 0.1 to 0.8 mm thick, roughness from 0.03 to 1.0 μm Ra, hardness 800 to 1200 HV, finely ground and super-finished.
6. Tungsten carbide+PTFE layer: 0.1 to 0.8 mm thick, roughness from 0.03 to 2.5 μm Ra, hardness 900 to 1400 HV, finely ground or not.
7. Stainless steel: 0.1 to 2.5 mm thick, roughness from 0.5 to 1.5 μm Ra, hardness 28 to 42 HRC.
8. Chromium-plated: 0.05 to 0.25 mm thick, roughness from 0.5 to 1.5 μm Ra, hardness 700 to 1200 HV.

The mating roll or the surface of the mating roll can be constructed from polyester, modified polyester, high-temperature polyamide, phnapphlape-based polyester, phnapphlape-based polymer, or a polyethylene naphtalate polymer. The crêping belt can be constructed from polyurethane, silicone rubber and the materials previously listed for the mating roll. The crêping belt can be comprised of embossed material. Provision can be made for a coating with nanoparticles in order to increase the wear resistance of all the materials.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a section of an inventive apparatus, and

FIG. 2 shows a variant of the apparatus from FIG. 1.

Corresponding reference characters indicate corresponding parts throughout the several views. The exemplifications set out herein illustrate one embodiments of the invention and such exemplifications are not to be construed as limiting the scope of the invention in any manner.

### DETAILED DESCRIPTION OF THE INVENTION

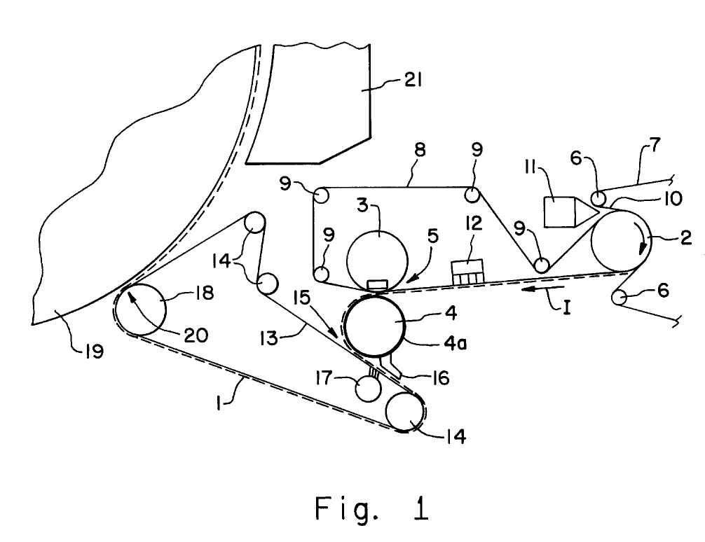

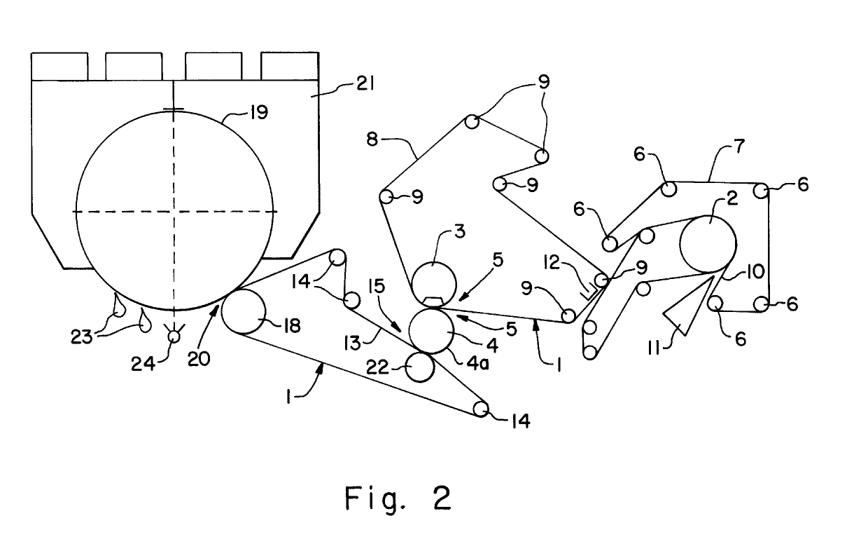

Referring now to the drawings, and more particularly to FIGS. 1-2, there is shown a represented section of the apparatus of the present invention for treating fibrous web 1, in particular a tissue paper web, comprises forming roll 2, over which fibrous web 1 is transported, and downstream therefrom roll pair 3, 4 with shoe press roll 3 and soft roll 4, between which press nip 5 is constructed. Together with fibrous web 1, dewatering belt 7 is transported via deflecting rolls 6 around forming roll 2. Similarly, together with fibrous web 1 dewatering belt 8 is transported through press nip 5. Also, dewatering belt 8 is transported via deflecting rolls 9 and together with fibrous web 1 around forming roll 2. Hence between dewatering belt 7 and dewatering belt 8 there is formed intake nip 10 in which fibrous suspension is fed via flowbox 11 onto forming roll 2. On the side of dewatering belt 8 facing away from fibrous web 1 there is in addition suction element 12 by means of which fibrous web 1 is sucked against dewatering belt 8.

Downstream from press nip 5 in the web running direction I, crêping belt 13, which is transported over deflecting rolls 14, rests against soft roll 4. Hence between crêping belt 13 and soft roll 4 there is a created crêping nip 15 which is limited on the one side by surface 4a of soft roll 4 and on the other side by crêping belt 13. Provided on the exit side of crêping nip 15 are doctor blade 16 and suction apparatus 17. Doctor blade 16 is not used here for crêping but for cleaning soft roll 4.

Arranged in the loop of crêping belt 13 there is also roll 18 which together with drying cylinder 19, in particular a Yankee cylinder, forms another press nip 20. Downstream from press nip 20 in the web running direction there is arranged drying hood 21 on drying cylinder 19.

As is shown in FIG. 2, it is possible to arrange on the side of crêping belt 13 opposite mating roll 4 a crêping roll or suction press roll 22. Pictured in FIG. 2 is also a different headbox. Otherwise the variant from FIG. 2 conforms however with the variant from FIG. 1.

The material and/or structure of surface 4a of roll 4, which forms the web supporting face for fibrous web 1 in crêping nip 15, and the surface of crêping belt 13 are coordinated with each other with a view to reducing the wear of crêping belt 13. In particular the coordination is undertaken such that a small coefficient of friction between crêping belt 13 and surface 4a of roll 4 results. For example crêping belt 13 can have humps of soft material (not shown here). The hardness of the humps can lie in this case between approximately 20 and approximately 120 Pussey & Jones. In particular PTFE, meaning polytetrafluoroethylene, is possible as a material for surface 4a of roll 4. Crêping belt 13 can be comprised of TAD fabric or spiral-linked fabric. Furthermore it can be permeable or impermeable, woven or non-woven.

Press nip 20 on drying cylinder 19 can be constructed likewise as a crêping nip. A relative speed then exists between drying cylinder 19 and crêping belt 13. Press nip 20 on drying cylinder 19 can also be constructed as a shoe press nip, and mating roll 18 can also be constructed as a suction press roll. Unlike crêping nip 15, crêping nip 20 is thus constructed as a press nip. Mating roll 18 can be constructed in addition as a soft pressing roll or as a hard pressing roll. However it is also possible for crêping nip 15 to be constructed as a belt press nip. Then crêping belt 13 has preferably a tensile strength of at least 40 kN/m, in particular at least 50 kN/m and more preferably at least 60 kN/m. Fibrous web 1 has moreover preferably a mass of approximately 15 g/m² to approximately 40 g/m².

Using the apparatus of the present invention it is possible to achieve a good crêping effect with a simultaneously low level of wear on crêping belt 13.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 Fibrous web
2 Forming roll
3 Shoe press roll
4 Soft roll
4a Surface of 4
5 Press nip
6 Deflecting roll
7 Dewatering belt
8 Dewatering belt
9 Deflecting roll
10 Intake nip
11 Flowbox
12 Suction device
13 Crêping belt
14 Deflecting roll
15 Crêping nip
16 Doctor blade
17 Suction apparatus
18 Mating roll
19 Drying cylinder
20 Press nip
21 Drying hood
22 Crêping roll/suction press roll:
23 Crêping and cleaning blade
24 Coating jet
I Web running direction

What is claimed is:

1. Apparatus for treating a fibrous web, comprising:
a crêping belt;
a mating roll including a web supporting face with a surface, said web supporting face movable at a relative speed with respect to said crêping belt; and
at least one crêping nip through which the fibrous web can pass, said at least one crêping nip limited on one side by said crêping belt and limited on an other side by said web supporting face;
wherein at least one of said surface of said web supporting face and a material from which said web supporting face is formed are selected with a view to inhibit wear of said crêping belt caused by operation of said apparatus.

2. The apparatus according to claim 1, wherein said fibrous web is a tissue paper web.

3. The apparatus according to claim 1, wherein said crêping belt and said web supporting face are coordinated such that a small coefficient of friction results.

4. The apparatus according to claim 1, wherein said crêping belt has humps made from soft material.

5. The apparatus according to claim 4, wherein said humps have a hardness between approximately 20 and approximately 120 Pussey & Jones.

6. The apparatus according to claim 1, wherein said web supporting face is comprised of polytetrafluoroethylene (PTFE).

7. The apparatus according to claim 1, wherein a press nip is provided upstream from said at least one crêping nip in the web running direction.

8. The apparatus according to claim 7, wherein said press nip is one of a longitudinal nip, a shoe press nip, a roll nip and a felted nip.

9. The apparatus according to claim 1, wherein said crêping belt is comprised of a structured fabric, said structured fabric being one of a TAD fabric and a spiral-linked fabric.

10. The apparatus according to claim 1, wherein said crêping belt is one of permeable and non-permeable.

11. The apparatus according to claim 1, wherein said crêping belt is one of a woven material and a non-woven material.

12. The apparatus according to claim 1, wherein one of a drying cylinder is arranged downstream from said crêping nip, and a crêping nip is constructed on said drying cylinder, said drying cylinder being a Yankee cylinder.

13. The apparatus according to claim 12, wherein a press nip is constructed on said drying cylinder by means of said mating roll, through which said fibrous web can pass together with said crêping belt.

14. The apparatus according to claim 12, wherein the contact area between one of said crêping belt and said drying cylinder and said crêping belt and said mating roll is between approximately 20% and 70%.

15. The apparatus according to claim 14, wherein the contact area between one of said crêping belt and said drying cylinder and said crêping belt and said mating roll is between approximately 25% and 50%.

16. The apparatus according to claim 14, wherein the contact area between one of said crêping belt and said drying cylinder and said crêping belt and said mating roll is approximately 30%.

17. The apparatus according to claim 13, wherein said press nip on said drying cylinder is formed by one of a suction press roll, a press roll and a shoe press roll with an extended roll nip.

18. The apparatus according to claim 1, wherein said crêping nip is constructed without a mechanical pressing device.

19. The apparatus according to claim 1, wherein said crêping nip is constructed with a mechanical pressing device.

20. The apparatus according to claim 19, wherein said mechanical pressing device is a soft pressing roll.

21. The apparatus according to claim 19, wherein said mechanical pressing device is a hard pressing roll.

22. The apparatus according to claim 19, wherein said mechanical pressing device is a belt press.

23. The apparatus according to claim 22, wherein the belt of said belt press has a tensile strength of at least 40 kN/m.

24. The apparatus according to claim 22, wherein the belt of said belt press has a tensile strength of at least 50 kN/m.

25. The apparatus according to claim 22, wherein the belt of said belt press has a tensile strength of at least 60 kN/m.

26. The apparatus according to claim 1, wherein said fibrous web has a mass of approximately 15 g/m to approximately 40 g/m².

27. The apparatus according to claim 1, wherein on the side of said crêping belt opposite said mating roll, there is one of a crêping roll and a suction press roll.
